(19) United States
(12) Patent Application Publication
(10) Pub. No.: US 2008/0203245 A1
(43) Pub. Date: Aug. 28, 2008

(54) SEALING CLIP ASSEMBLY

(76) Inventors: SYLVESTER S. CLARK, Skokie, IL (US); Thomas A. Benoit, Bourbonnais, IL (US); Brian R. Peek, Mokena, IL (US); Timothy D. Pearson, Palos Hills, IL (US)

Correspondence Address: ILLINOIS TOOL WORKS INC., 3600 WEST LAKE AVENUE, PATENT DEPARTMENT, GLENVIEW, IL, 60025, US

(21) Appl. No.: 11/972,058

(22) Filed: Jan. 10, 2008

Related U.S. Application Data
(60) Provisional application No. 60/902,713, filed on Feb. 22, 2007.

(51) Int. Cl. F16L 3/22

(52) U.S. Cl. 248/68.1; 248/74.3

(57) ABSTRACT

A sealing clip assembly is configured to secure at least a fluid-conveying tube to a structure. The sealing clip assembly includes a main body and at least one auxiliary dampening member. The main body includes a first tube support portion connected to a second tube support portion through a hinge. The first tube support portion includes a first tube channel, while the second tube support portion includes a second tube channel. The auxiliary dampening member covers the first and second tube channels, such that the auxiliary dampening member overhangs the main body at ends of the first and second tube channels.

### RELATED APPLICATIONS

This application relates to and claims priority benefits from U.S. Provisional Patent Application No. 60/902,713 entitled “Dampening Compression Sealing Clip Assembly,” filed Feb. 22, 2007, which is hereby incorporated by reference in its entirety.

### FIELD OF THE INVENTION

Embodiments of the present invention generally relate to clip assemblies, and more particularly, to dampening compression sealing clip assemblies formed of two materials, such as nylon and thermoplastic elastomer.

### BACKGROUND OF THE INVENTION

Clip assemblies have been used with various applications. For example, in the automotive industry, clip assemblies are commonly used to securely locate and support rigid tubes. The clip assemblies may be formed of various materials, including plastic, steel, and elastomers. Typically, each clip assembly is secured into position with respect to a vehicle structure by a fastening device, such as a screw, bolt, or the like.

A tube secured by a clip assembly may convey various fluids. For example, Freon or fuel may flow through the tube. The fluid flow through the tube may vibrate the tube. As such, a typical clip assembly is configured to reduce and/or prevent the vibrations from transmitting into the vehicle frame or other such structure.

Conventional clip designs typically do not seal out debris that may adversely impact the outer protective coating of a tube. For example, when abrasive substances, such as dirt, lodge between the plastic of the clip and the tube, the abrasive substances abrade or otherwise rub away the protective outer layer of the tube. Thus, the tube is susceptible to corrosion in the eroded area(s).

### SUMMARY OF THE INVENTION

Embodiments of the present invention provide a sealing clip assembly that absorbs vibrations and shocks that may be generated through fluid flowing through tubes secured within the clip assembly. Additionally, embodiments of the present invention prevent fluid and debris from infiltrating the interior of a clip assembly.

Certain embodiments of the present invention provide a sealing clip assembly configured to secure at least a fluid-conveying tube to a structure. The sealing clip assembly includes a main body and at least one auxiliary dampening member.

The main body includes a first tube support portion connected to a second tube support portion through a hinge. The first tube support portion includes a first tube channel, and the second tube support portion includes a second tube channel.

The at least one auxiliary dampening member covers the first and second tube channels and may include ribs within the first and second tube channels. The ribs are configured to cushion the at least one fluid-conveying tube. The ribs may be longitudinally aligned over lengths of the first and second tube channels. The at least one auxiliary dampening member overhangs the main body at ends of the first and second tube channels in order to sealingly engage the at least one fluid-conveying tube that is configured to be trapped within the first and second tube channels. Drains may also be formed in the auxiliary dampening member (and the main body).

The main body may be formed of plastic, while the at least one auxiliary dampening member may be formed of thermoplastic elastomer. The at least one auxiliary dampening member may be a single auxiliary dampening layer that extends between the first and second tube support portions.

The first tube support portion may also include a third tube channel, while the second tube support portion may also include a fourth tube channel, in order to accommodate multiple tubes. The first and third tube channels may differ in size, while the second and fourth tube channels may also differ in size, in order to accommodate tubes of different sizes.

### BRIEF DESCRIPTION OF SEVERAL VIEWS OF THE DRAWINGS

FIG. 1 illustrates a top isometric view of a sealing clip assembly according to an embodiment of the present invention.

FIG. 2 illustrates a lateral view of a tube support portion of a sealing clip assembly according to an embodiment of the present invention.

FIG. 3 illustrates a top plan view of a tube support portion of a sealing clip assembly according to an embodiment of the present invention.

FIG. 4 illustrates a bottom isometric view of a sealing clip assembly according to an embodiment of the present invention.

FIG. 5 illustrates a top plan view of a sealing clip assembly according to an embodiment of the present invention.

FIG. 6 illustrates an end view of a sealing clip assembly according to an embodiment of the present invention.

FIG. 7 illustrates a bottom plan view of a tube support portion of a sealing clip assembly according to an embodiment of the present invention.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE INVENTION

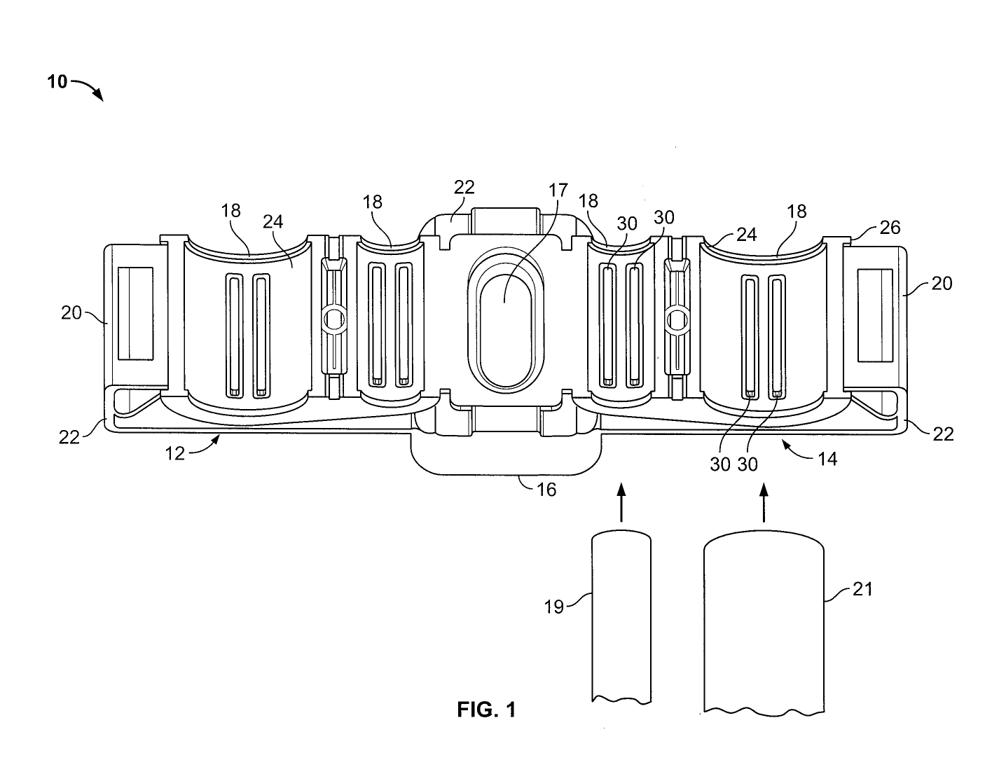

FIG. 1 illustrates a top isometric view of a sealing clip assembly 10 according to an embodiment of the present invention. The sealing clip assembly 10 includes two tube retaining portions 12 and 14 connected to one another through a hinge 16. The hinge 16 includes a fastener through passage 17 that is configured to receive a fastener that is used to secure the clip assembly 10 to a structure, such as frame within a vehicle.

In operation, tubes 19 and 21 are positioned within tube channels 18 formed in the tube support portion 12. Each tube channel 18 is semi-circular in cross-section and is configured to receive and retain a tube. The other tube support portion 14 is then pivoted over the tube support portion 12 through the hinge 16 to secure the tubes in position between the opposed tube channels 18 of the tube support portions 12 and 14. The hinge 16 allows the tube support portions 12 and 14 to pivot with respect to one another so that one tube support portion 12 or 14 securely latches over another tube support portion 12 or 14 to trap tubes with and between the opposing tube channels 18. The tube support portions 12 and 14 may include reciprocal locking members 20 at distal ends that allow the tube retaining portions 12 and 14 to snapably, latchably or otherwise removably secure to one another.

As shown in FIG. 1, each tube support portion 12 and 14 includes two tube channels 18, each of different size. The different sized tube channels 18 are configured to receive and retain different sized tubes. Optionally, the tube channels 18 may all be the same size. Further, more or less tube channels 18 than those shown may be used. For example, each tube support portion 12 and 14 may include one tube channel 18, instead of two.

The clip assembly 10 includes a main body 22 that is a base for the tube support portions 12 and 14 and the hinge 16. The main body 22 may be formed of various materials, such as plastic, rubber or the like. For example, the main body 22 may be formed of nylon.

An auxiliary dampening layer 24 is secured over each of the tube support portions 12 and 14. That is, the dampening member or layer 24 overlays the main body 22 and provides a cushion with respect to the tube channels 18. The auxiliary dampening layer 24 may also overlay the hinge 16. The auxiliary dampening layer 24 may be a single piece of thermoplastic elastomer (TPE), such as thermoplastic polyolefin (TPO), that spans between the tube support portions 12 and 14 over the tube channels 18. A single auxiliary dampening layer 24 that extends between the tube support portions may be easier to manufacture and assemble to the main body 22, as opposed to separate and discrete layers that individually cover the tube channels 18. Alternatively, each tube channel 18 may be covered by a separate and distinct auxiliary dampening member. Thus, instead of a single auxiliary dampening layer 24 spanning over the entire top surface (as shown in FIG. 1) of the main body 22, separate and distinct auxiliary dampening members may overlay the tube channels 18.

The auxiliary dampening member or layer 24 may be snapably, latchably or otherwise secured to the main body 22 through fasteners, or it may be bonded or molded directly to the main body 22. Optionally, the auxiliary dampening member or layer 24 may be secured over the main body 22 through an interference fit.

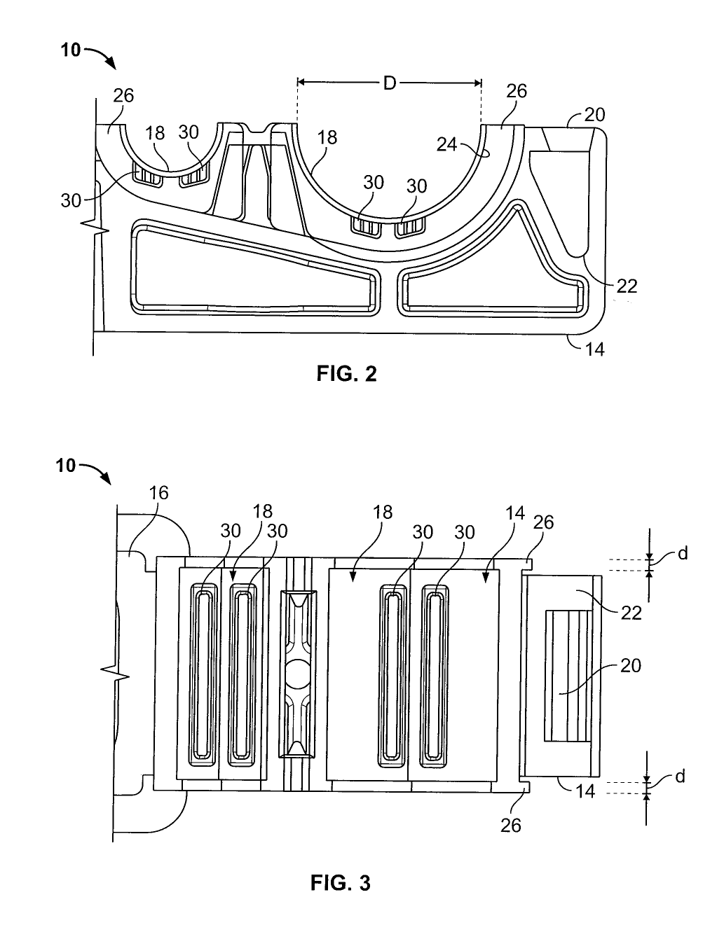

FIGS. 2 and 3 illustrate lateral and top plan views, respectively, of the tube support portion 14 of the sealing clip assembly 10. The tube support portion 12 is a mirror image of the tube support 14. Referring to FIGS. 1-3, the auxiliary dampening layer 24 overhangs both ends of the tube channels 18 on both outer side edges of the main body 22 by a distance d (as shown in FIG. 3). The overhangs 26 form sealing members at each end of the tube channels 18. As shown in FIG. 2, in particular, the overhangs 26 provide a thick lip of material that has a smaller interior diameter D (shown, e.g., with respect to one tube channel 18 in FIG. 1) than the tube channel areas formed in the main body 22. As such, the overhangs 26 are able to compressively sandwich tubes situated within the tube channels 18.

When the tube support portions 12 and 14 are secured to one another, tubes trapped within the tube channels 18 are compressively sandwiched between the auxiliary dampening layer 24 of the tube support portions 12 and 14. The auxiliary dampening layer 24 absorbs vibratory energy generated by fluid flow through the tubes. The overhangs 26 sealingly engage the tubes trapped within the tube channels 18 at the ends of the tube channels 18, thereby providing a barrier against fluid and debris infiltration.

As shown in FIGS. 1-3, the auxiliary dampening layer 24 may also include longitudinal ribs 30 over a substantial length of the tube channels 18. The longitudinal ribs 30 provide a stable and contiguous cushion over the length of a tube within a particular tube channel. Optionally, the ribs may be horizontally aligned such that they form radial rings with respect to the tube channels 18. As shown, each tube channel 18 may include two ribs 30. However, more or less ribs 30 than those shown within each tube channel 18 may be used. The ribs 30 may upwardly extend from the auxiliary dampening layer 24. The ribs 30 prevent tubes within the tube channels 18 from bottoming out with respect to the auxiliary dampening layer 24 and/or the main body 22. As such, the ribs 30 act as shock absorbers, thereby providing vibration absorbing cushions for the tubes trapped within the tube channels 18.

When the tube support portions 12 and 14 are folded over and latchably secured to one another, the opposing tube channels 18 form tube passages in which tubes are configured to be trapped. In this position, the overhangs 26 form compression seals with each tube. As noted above, the overhangs 26 extend past the outer lateral edges of the main body 22, particularly over the ends of the tube channels 18. The compression seals formed by the overhangs 26 allow for increased flexibility in that the resilient material of the auxiliary dampening layer 24 sealingly conforms to the shape of the tube trapped between the opposing tube channels 18. The overhangs 26 of the auxiliary dampening layer 24 or members provide better flexibility and tube conformity because the material of the auxiliary dampening layer 24 or members, e.g., TPE, is not constricted such as a rigid structure. That is, the auxiliary dampening layer 24 is able to expand and contract depending on the size and shape of a particular tube.

The compression seals formed by the overhangs 26 protect against poor sealing caused by creep. That is, the compression seals formed by the overhangs 26 prevent creep in that they are able to automatically adapt to a tube so that they expand and contract to maintain a sealing engagement with the tube. Thus, the overhangs block contaminants and debris from infiltrating the tube channels 18.

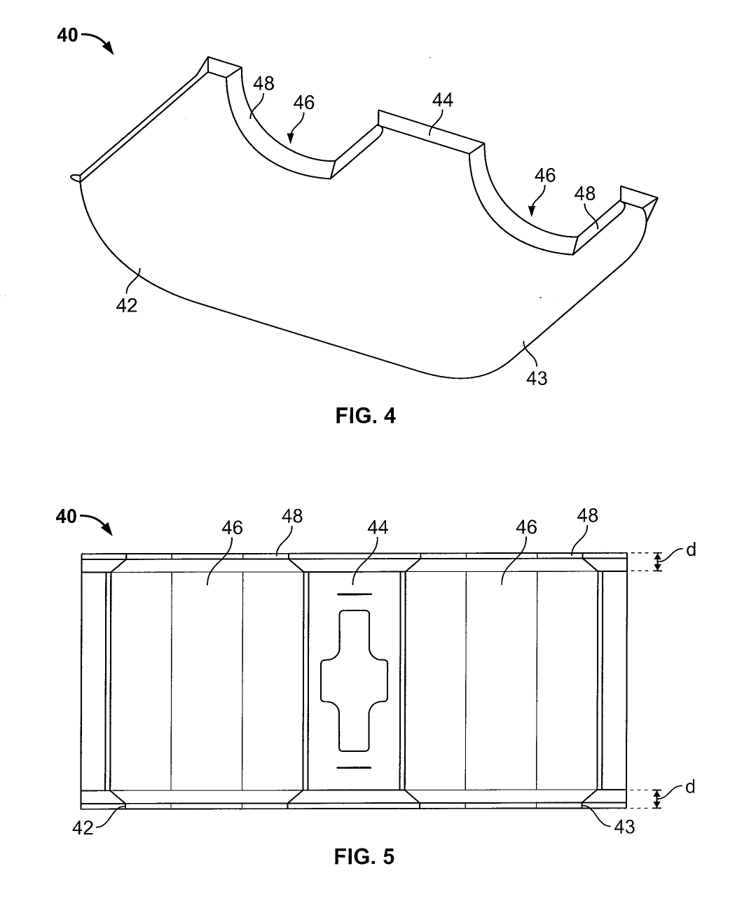

FIG. 4 illustrates a bottom isometric view of a sealing clip assembly 40 according to an embodiment of the present invention. The sealing clip assembly 40 includes two tube support portions 42 and 43 connected to one another through a hinge 44. Each tube support portion 42 and 43 includes one tube channel 46. Similar to the clip assembly 10, the clip assembly 40 includes sealing lips 48 that are outside of the tube channels 46.

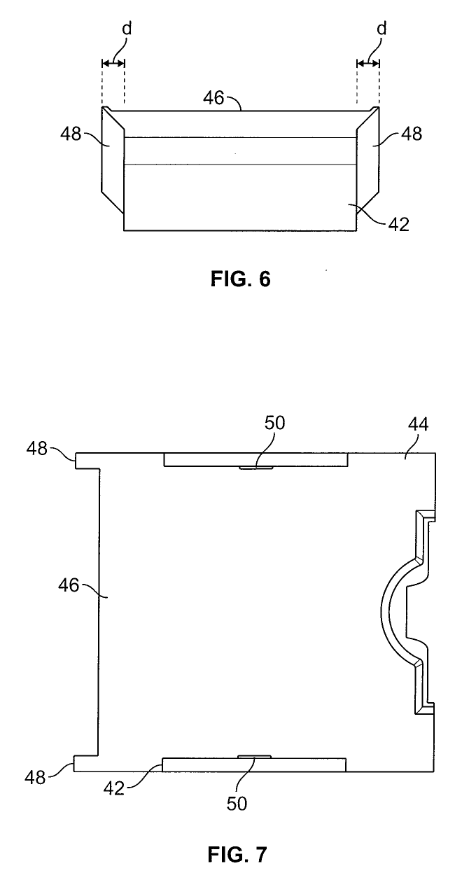

FIGS. 5 and 6 illustrate top plan and end views, respectively, of the sealing clip assembly 40. The sealing lips 48 extend past the ends of the tube channels 46 a distance d, thereby providing a seal against fluid and debris when the tube support portions 42 and 43 latchably secure to one another and trapping a tube within the opposed tube channels 46.

FIG. 7 illustrates a bottom plan view of the tube support portion 42 of the sealing clip assembly 40. Slits or other such openings form drains 50 proximate the union of the tube channels 46 and the sealing lips 48. The drains 50 allow any fluid that may enter the tube channels 46 to drain out of the clip assembly 40. Thus, even if fluid infiltrates the tube channels 46, that fluid drains out of the clip assembly 40 through the drains 50. The draining effect prevents corrosive material from abrading tubes within the tube channels 46.

Thus, embodiments of the present invention provide a sealing clip assembly that absorbs vibrations and shocks that may be generated through fluid flowing through tubes secured within the clip assembly. Additionally, embodiments of the present invention prevent fluid and debris from infiltrating the interior of a clip assembly.

While various spatial and directional terms, such as upper, bottom, lower, mid, lateral, horizontal, vertical, and the like may used to describe embodiments of the present invention, it is understood that such terms are merely used with respect to the orientations shown in the drawings. The orientations may be inverted, rotated, or otherwise changed, such that an upper portion is a lower portion, and vice versa, horizontal becomes vertical, and the like.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

1. A sealing clip assembly configured to secure at least a fluid-conveying tube to a structure comprising:
a main body comprising a first tube support portion connected to a second tube support portion through a hinge, said first tube support portion comprising a first tube channel, and said second tube support portion comprising a second tube channel; and
at least one auxiliary dampening member covering said first and second tube channels, wherein said at least one auxiliary dampening member overhangs said main body at ends of said first and second tube channels.

2. The sealing clip assembly of claim 1, wherein said at least one auxiliary dampening member comprises ribs within said first and second tube channels.

3. The sealing clip assembly of claim 2, wherein said ribs are longitudinally aligned over lengths of said first and second tube channels.

4. The sealing clip assembly of claim 1, wherein said at least one auxiliary dampening member is a single auxiliary dampening layer that extends between said first and second tube support portions.

5. The sealing clip assembly of claim 1, wherein said main body is formed of plastic.

6. The sealing clip assembly of claim 1, wherein said auxiliary dampening member is formed of thermoplastic elastomer.

7. The sealing clip assembly of claim 1, wherein said first tube support portion further comprises a third tube channel, and wherein said second tube support portion further comprises a fourth tube channel.

8. The sealing clip assembly of claim 7, wherein said first and third tube channels differ in size, and wherein said second and fourth tube channels differ in size.

9. The sealing clip assembly of claim 1, wherein said at least one auxiliary dampening member overhangs said main body past said first and second tube channels.

10. The sealing clip assembly of claim 1, further comprising drains formed in said auxiliary dampening member.

11. A sealing clip assembly configured to secure at least a fluid-conveying tube to a structure comprising:
a main body comprising a first tube support portion connected to a second tube support portion through a hinge, said first tube support portion comprising a first tube channel, and said second tube support portion comprising a second tube channel; and
at least one auxiliary dampening member covering said first and second tube channels, said at least one auxiliary dampening member comprising ribs within said first and second tube channels, said ribs configured to cushion the at least one fluid-conveying tube, said at least one auxiliary dampening member overhanging said main body at ends of said first and second tube channels in order to sealingly engage the at least one fluid-conveying tube that is configured to be trapped within said first and second tube channels.

12. The sealing clip assembly of claim 11, wherein said ribs are longitudinally aligned over lengths of said first and second tube channels.

13. The sealing clip assembly of claim 11, wherein said at least one auxiliary dampening member is a single auxiliary dampening layer that extends between said first and second tube support portions.

14. The sealing clip assembly of claim 11, wherein said main body is formed of plastic.

15. The sealing clip assembly of claim 11, wherein said auxiliary dampening member is formed of thermoplastic elastomer.

16. The sealing clip assembly of claim 11, wherein said first tube support portion further comprises a third tube channel, and wherein said second tube support portion further comprises a fourth tube channel.

17. The sealing clip assembly of claim 16, wherein said first and third tube channels differ in size, and wherein said second and fourth tube channels differ in size.

18. The sealing clip assembly of claim 11, wherein said at least one auxiliary dampening member overhangs said main body past said first and second tube channels.

19. The sealing clip assembly of claim 11, further comprising drains formed in said auxiliary dampening member.

20. A sealing clip assembly configured to secure two fluid-conveying tubes to a structure comprising:
a main body formed of plastic, rubber or nylon, said main body comprising a first tube support portion connected to a second tube support portion through a hinge, said first tube support portion comprising first and second tube channels, and said second tube support portion comprising a third and fourth tube channel, wherein said first and third tube channels are the same size and are configured to align with respect to one another, and wherein said second and fourth tube channels are the same size and are configured to align with respect to one another; and
at least one auxiliary dampening member formed of thermoplastic elastomer, said at least one auxiliary dampening member covering said first, second, third and fourth tube channels, said at least one auxiliary dampening member comprising ribs within said first, second, third and fourth tube channels, said ribs configured to cushion the at least one fluid-conveying tube, wherein said at least one auxiliary dampening member overhangs said main body at ends of said first, second, third and fourth tube channels in order to sealingly engage the two fluid-conveying tubes that are configured to be trapped within said first, second, third and fourth tube channels, wherein said at least one auxiliary dampening member overhangs said main body past said first, second, third and fourth tube channels.
